(19) United States
(12) Patent Application Publication
(10) Pub. No.: US 2005/0252835 A1
(43) Pub. Date: Nov. 17, 2005

(54) Sieving device having beating elements

(76) Inventor: Rolf Kadel, Weinheim (DE)

Correspondence Address: THE FIRM OF KARL F ROSS, 5676 RIVERDALE AVENUE, PO BOX 900, RIVERDALE (BRONX), NY, 10471-0900, US

(21) Appl. No.: 10/525,280

(22) PCT Filed: Jun. 26, 2003
(86) PCT No.: PCT/EP03/06780

§ 371 Date: Feb. 18, 2005

(30) Foreign Application Priority Data
Aug. 26, 2002 (DE) 10239667.1

(51) Int. Cl. B07B 1/54; B07B 1/34

(52) U.S. Cl. 209/382; 209/326

(57) ABSTRACT

The invention relates to a sieving device provided with a sieving mat (2), which has sieving openings, and with beating elements (7), which are located underneath the sieving mat and which strike against the underside of the sieving mat (2) in order to free the sieving mat (2) from material to be sieved that is clogging the sieving openings. Said beating elements (7) are fastened to at least one elongated tensioned traction mechanism (5) such as a cable or band that extends underneath the sieving mat (2).

The inventions relates to a sieve with a screen having openings and beaters that are underneath the screen and that can strike the lower face of the screen in order to free the screen from material plugging the screen openings.

German utility model 84 35 585 describes a sieve with bar-shaped beaters that are secured to an elastic matte that is mounted underneath the flexible screen. Both screens are mounted on tensioning rods that reciprocate and thus insure that the lower screen is taut and strikes with its beaters against the lower face of the upper screen in order to knock big particles out of the upper screen. The provision of a second screen underneath the first one is expensive and entails considerable extra manufacturing time.

It is an object of the invention so to improve on the above-described type of sieve that, with simpler construction and assembly, the sieve openings can be reliably kept free of large and sticky particles.

This object is attained in that the beaters are mounted on an elongated longitudinally tensioned actuating element, such as a cable or belt, that extends underneath the screen.

The mounting of the beaters on elongated actuating elements is particularly simple from the manufacturing point of view and leads to particularly good results when cleaning.

Preferably the beaters are spherical. It is also suggested that the actuating element extend transversely, longitudinally, or diagonally of a movement direction of the material being sieved.

It is particularly advantageous when the screen is formed by a replaceable screen assembly that is surrounded by a downwardly projecting frame so that a sieve can be formed by several such screen assemblies. In this manner each removable screen assembly has its own system for clearing the screen openings of large and sticky particles.

For particularly simple assembly and installation, ends of the actuating elements are solidly releasably connected or latched to the frame of the screen.

An alternative suggestion is to provide beaters underneath a screen spanned over a full working width of a sieve, ends of the actuating elements carrying two or more beaters being fixed to side walls of the sieve. The ends of the actuating element are solidly releasably connected or latched to side walls of the sieve. It is also advantageous when transverse beams are mounted between the beaters in a lower region of the sieve and support the actuating elements.

Preferably it is suggested that the transverse beams extend transversely or longitudinally of a movement direction of the material being sieved.

It is particularly easy to exchange the beaters when the screen is releasably attached, in particular by hooking, at two opposite edges on side walls of the sieve. In the simplest construction the actuating element extends through the beaters.

This also aids in changing the beaters on the actuating elements.

In an alternative attachment system a lower face of the screen is provided with projecting flat iron bars that are embedded in the plastic of the screen and that serve as attachment points for the actuating elements.

Embodiments of the invention are shown in the drawing and more closely described in the following. Therein:

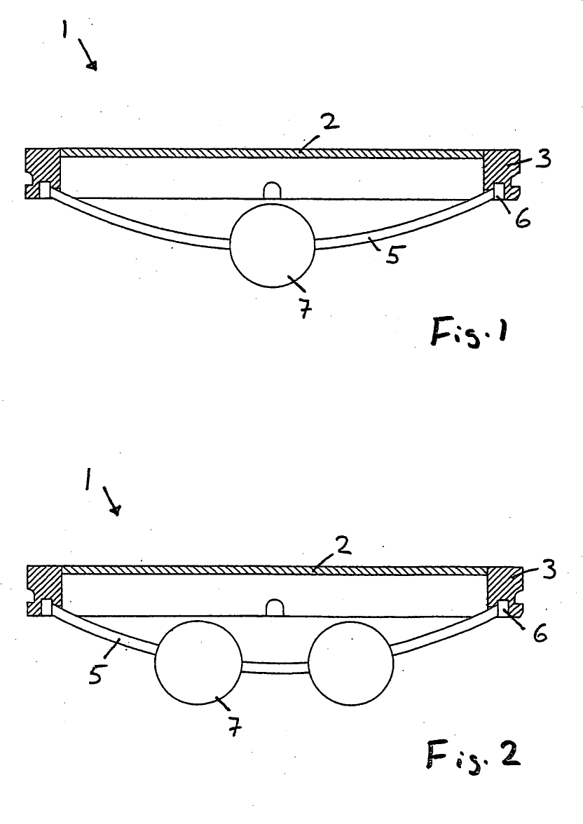

FIG. 1 is a vertical section through a single framed sieve assembly with one beater on an actuating element;

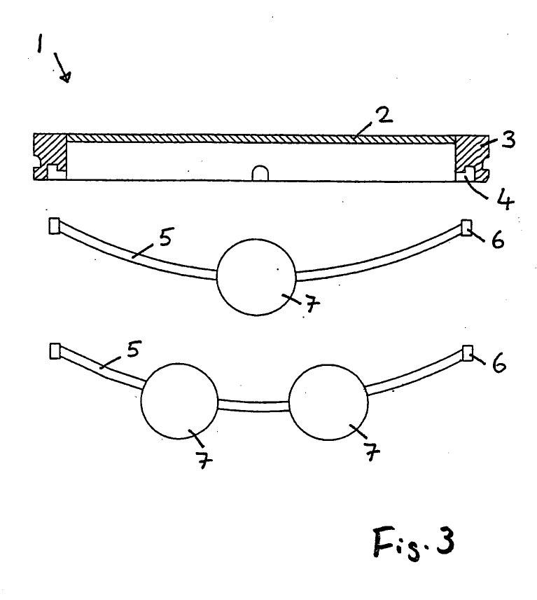

FIG. 2 is the sieve assembly according to FIG. 1 with two beaters on the actuating element;

FIG. 3 is the sieve assembly according to FIG. 1 or 2 with two actuating elements with one and two beaters;

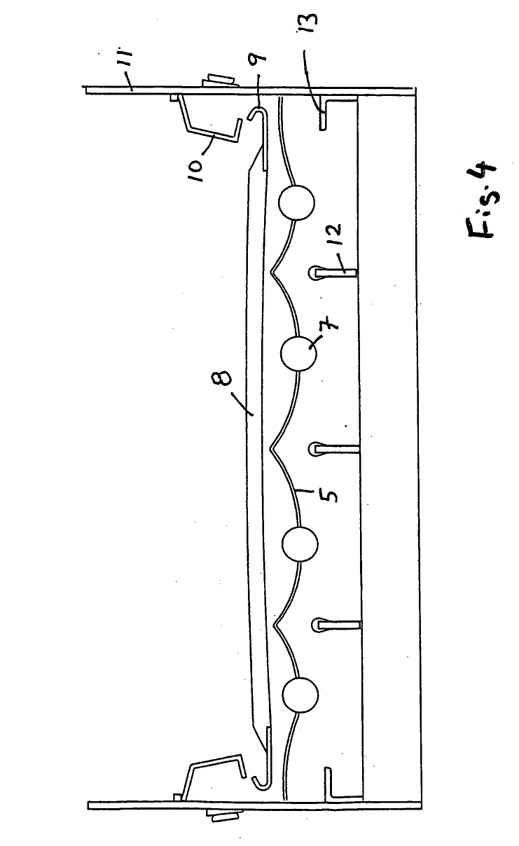

FIG. 4 is a vertical section through a sieve with a screen extending over the entire width of the sieve and underneath beaters.

In FIGS. 1 to 3, a sieve assembly 1 is shown having a rectangular screen 2 in turn having four edges with respective frame elements 3 that project downwardly past the screen 2. The screen 2 and frame elements 3 are made of plastic and secured to each other, in particular by gluing, casting, or welding, or the screen and frame elements are unitarily formed of plastic. The plastic is preferably polyurethane. Several such assemblies form the sieve surfaces of a sieve and are individually easily switched.

The frame elements 3 have on their lower faces a downwardly open groove or opening 4 in which ends 6 of an elongated actuating element 5 are fixed. To accomplish this the ends 6 of the elements 6 are enlarged to have the same size and shape as the openings 4 so that they fit and are held complementarily in the openings 4.

The openings 4 in the frame elements 3 can also be made with an inwardly extending projection that the end 6 is looped around so as to lock it in place.

The actuating element 5 is provided with beaters 7 that are preferably made of plastic and that can have different shapes. In all of the embodiments the beaters 7 are spherical balls.

The actuating element with its beaters can extend transversely, longitudinally, or diagonally to the movement direction of the material being sieved.

The embodiment shown in FIG. 4 is a sieve with a screen extending over the entire working width of the sieve and having edges provided with mounting clips 9 that are hooked on mounting rails 10 that are fixed to side walls 11 of the sieve. In this manner the screen 8 is solidly held in the sieve.

Underneath the screen 8 is an actuating element 5 whose ends are releasably mounted on the side walls 11, in particular on mounts 3 of the side walls 11. To this end the mount 13 can have a bore.

In the lower region of the sieve there are transverse beams 12 on which the actuating element 5 lies with at least one beater 7 on the element 5 between each pair of beams 12. FIG. 4 shows these elements when raised.

The beams 12 can extend transversely or longitudinally to the movement direction of the material being sieved, depending how the screen 8 is installed. With a longitudinally tensioned screen 8 the beams extend transverse to the movement direction.

In a further unillustrated embodiment flat iron bars are set on the lower face of the screen in the plastic of the screen so as to project downward and serve as mounting points for the actuating element or elements.

1-12. (canceled)

13. A sieve comprising:
a frame; and
a plurality of identical screen assemblies removably mounted in the frame and each having
a generally horizontal screen,
an annular frame surrounding the screen, connected to outer edges of the screen, and projecting downward past the screen;
an elongated and longitudinally tensioned element having opposite ends anchored in the frame and extending underneath the screen, and
a beater on the elongated element engageable with a lower face of the respective screen for freeing particles from openings in the screen.

14. The sieve defined in claim 13 wherein the ends of the element are removably secured in the frame.

15. The sieve defined in claim 13 wherein the beaters are balls.

16. The sieve defined in claim 13 wherein the element is a cable.

17. The sieve defined in claim 13 wherein the element is a belt.

18. The sieve defined in claim 13 wherein the frame and screen are unitarily formed of plastic.
